(19) United States
(12) Patent Application Publication
(10) Pub. No.: US 2018/0354682 A1
(43) Pub. Date: Dec. 13, 2018

(54) Bottle Accessory Device and Method for Attaching to a Bottle and Dispensing Edible Substance

(71) Applicant: ROLANDO HUMBERTO PEREZ, MIRAMAR, FL (US)

(72) Inventor: ROLANDO HUMBERTO PEREZ, MIRAMAR, FL (US)

(21) Appl. No.: 15/618,708

(22) Filed: Jun. 9, 2017

(51) Int. Cl. B65D 23/12; B65D 1/02; B65D 43/16; B65D 85/80; A61J 1/03; B65D 85/34; B65D 85/60; B65D 85/72; B65D 43/02; B65D 55/16

(52) U.S. Cl. CPC B65D 23/12; B65D 1/023; B65D 43/16; B65D 85/80; B65D 55/16; B65D 85/34; B65D 85/60; B65D 85/72; B65D 43/02; A61J 1/03

(57) ABSTRACT

A bottle accessory device and method is defined by an annular, cavernous configuration that forms a snug encirclement with a neck portion of the bottle, while simultaneously storing and dispensing an edible substance. The device comprises an annular body has a cavity containing an edible substance, and a continuous sidewall having a sidewall opening. The annular body has an inner perimeter, an outer perimeter, and a body hole having a first diameter. A gate enables access to the cavity. A cap extends from the outer perimeter of the annular body to cover the bottle opening. A resilient gasket affixes inside the annular body and engages the neck portion of the bottle. The gasket has an inner edge, an outer edge, and a gasket hole. Resilient protruding members extend from the inner edge of the gasket to restrict and facilitate movement against the neck portion and the flange of bottle.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon.

The present invention is directed to a bottle accessory device and method is defined by an annular, cavernous configuration that forms a snug encirclement with a neck portion of the bottle, while simultaneously storing and dispensing an edible substance.

The inventor often consumes liquids from a bottle. The inventor also likes to snack edible substances while drinking. These edible substances were often in liquid and solid forms. However, the inventor recognized that it was often inconvenient to access and consume both liquid and solid edible substances simultaneously.

The inventor was aware that there were cups and containers that held both liquids and solid foods. But these combination cups were used for carrying drinks and snack foods were bulky and difficult to hold. Children were especially prone to tipping their drinks and require safeguards to keep liquids and snacks from spilling out on to adjacent surfaces. Further, most cups of this nature were not designed to contain healthy, nutritious edible substances in the form of both liquid and solid.

The inventor designed an annular, cavernous body that could detachably attach to a bottle, so that it could be held with one hand and squeezed to discharge an edible substance contained within. The idea was to enable the liquid to be consumed normally from the bottle by tuning the bottle over and accessing the bottle opening, and also dispense the edible substance directly from the annular body. The inventor also added a gate to access the edible substance in the cavity of the annular body.

The inventor recognized a problem in that the bottle was left open, especially if the bottle cap was misplaced. The inventor decided to integrate a cap in the annular body that could attach to the annular body, but move freely in relation to the bottle, so as to cover and uncover the bottle opening.

However, the inventor was not sure where on the bottle the annular body would attach. Through research, the inventor realized that the neck portion of the bottle had flanges and rings from the detached bottle cap. The inventor decided to leverage these protrusions to securely affix the annular body to the bottle neck.

The inventor developed an inner resilient gasket that affixed inside the inner perimeter of the annular body. The gasket was sixed and dimensioned to form a snug fit with the neck portion of the bottle. The inventor realized that the gasket was still slipping when the bottle was turned over to consume the liquid contained therein.

The inventor added a plurality of resilient protruding members that extended from the inner edge of the gasket. The protruding members would bend against the flanges at the neck portion of the bottle and restrict movement of the annular body when moving off the neck portion of the bottle.

For the foregoing reasons, there is a bottle accessory device and method is defined by an annular, cavernous configuration that forms a snug encirclement with a neck portion of the bottle, while simultaneously storing and dispensing an edible substance.

Food storage and delivery systems and methods have been utilized in the past; yet none with the characteristics of the present invention. See U.S. Pat. No. 7,111,748; 20130233858; and 20150272357.

For the foregoing reasons, there is a solid and liquid dietary dispensing system that simultaneously stores and dispenses a plurality of nutritional edible substances in the form of both a liquid and a solid, while also enabling access to the edible substances by squeezing the container or opening a gate in the cap.

### SUMMARY

The present invention describes a bottle accessory device and method for attaching to a bottle and dispensing edible substances. The bottle accessory device is defined by a generally annular, cavernous configuration that forms a snug encirclement with a neck portion of the bottle, while simultaneously storing and dispensing an edible substance. The bottle may include a bottle known in the art for containing an edible liquid substance, and comprising a wide body portion and a narrow neck portion having at least one flange and terminating at a bottle opening.

In one embodiment, the bottle accessory device detachably attaches to the neck portion of the bottle while simultaneously storing and dispensing an edible substance. The bottle accessory device enables the bottle to be manipulated with one hand, so as to enable a user to consume the liquid in the bottle and the edible substance in the bottle accessory device, while performing functions, such as walking, exercising, driving, and talking on the phone.

In one alternative embodiment, the bottle accessory device has at least one barrier that segregates the different edible substances from each other. In another embodiment, the bottle accessory device has a clam shell configuration.

In one embodiment, the bottle accessory device comprises a generally annular body defined by a cavity and a continuous sidewall having a sidewall opening. The continuous sidewall is generally smooth and forms a continuous circle. The cavity may be configured to contain an edible substance. The annular body is further defined by an inner perimeter and an outer perimeter. The annular body is further defined by a body hole having a first diameter.

In some embodiments, a gate enables access to the cavity of the annular body. The gate may hingedly move between an open position and a closed positon over the sidewall opening. When in the open position, the sidewall opening in the continuous sidewall enables the edible substance to be filled or dispensed from the cavity of the annular body. In other embodiments, a cap extends from the outer perimeter of the annular body. A flexible rod may connect the cap to the outer perimeter of the annular body. In this manner, the cap remains attached, but moves freely relative to the annular body to cover and uncover the bottle opening.

In some embodiments, the bottle accessory device comprises a generally resilient gasket that affixes inside the annular body and engages the neck portion of the bottle. The resilient gasket is defined by an inner edge, an outer edge, and a gasket hole. The resilient gasket is disposed generally coplanar to the annular body. In this manner, the outer edge of the resilient gasket fixedly fits inside the inner perimeter of the annular body. The gasket hole is defined by a second diameter that is generally smaller than the first diameter of the body hole of the annular body.

In some embodiments, a plurality of resilient protruding members extend from the inner edge of the resilient gasket. The resilient protruding members are disposed generally perpendicular to the resilient gasket. The resilient protruding members are also oriented in the same direction. The resilient protruding members bend when engaging the at least one flange of the neck portion of the bottle. In this manner, the resilient protruding members are configured to facilitate motion of the device in a first direction, and restrict motion of the device in a second direction.

For example, the resilient protruding members restrict movement of the device away from a body portion of the bottle. Conversely, the resilient protruding members are configured to facilitate movement of the device towards the body portion of the bottle. This results in the bottle accessory device being easy fitting onto the neck portion of the bottle, but difficult to remove from neck portion of the bottle. Further, the bottle accessory device does not move substantially when attached to the neck of the bottle. In this manner, the liquid in the bottle may be consumed without removing the bottle accessory device.

One objective of the present invention is to provide a bottle accessory device that simultaneously stores and dispenses edible substances in the form of both a liquid and a solid.

Another objective is to provide an annular body having a plurality of compartments wherein at least one compartment stores a solid edible substance and at least one compartment stores a liquid edible substance.

Another objective is to provide a resilient gasket that snugly encircles the neck portion of the bottle.

Another objective is to provide a second dimeter that is substantially the same as the diameter of the neck portion of the bottle.

Another objective of the present invention is to facilitate attachment of the bottle accessory device to the neck portion of the bottle.

Another objective of the present invention is to restrict detachment of the bottle accessory device from the neck portion of the bottle

Another objective of the present invention is to enable one-handed consumption of the liquid from the bottle and the edible substances from the cavity of the bottle accessory device.

Another objective is to provide a cap that attaches to the bottle accessory device and freely covers and uncovers the bottle opening.

Another objective is to provide a hinged gate that enables access to the cavity containing the edible substance.

Another objective is to provide at least one barrier that segregates different edible substances in the cavity of the annular body.

Yet another objective of the present invention is to provide fun and easy access to nutritional edible substances.

Yet another objective is to inexpensively manufacture a bottle accessory device that is operational with a variety of bottles.

### DRAWINGS

These and other features, aspects, and advantages of the present invention will become better understood with regard to the following description, appended claims, and drawings where:

FIG. 1 is a cross sectioned side view of an exemplary bottle accessory device operatively joined with a bottle and containing an edible substance, in accordance with an embodiment of the present invention;

FIG. 2 is a top view of the bottle accessory device shown in FIG. 1, in accordance with an embodiment of the present invention;

FIG. 3 is a cross sectioned side view of an alternative bottle accessory device having a clam shell configuration and operatively joined with a bottle, in accordance with an embodiment of the present invention;

FIG. 4 illustrates a flowchart diagram of an exemplary method for attaching to a bottle and dispensing an edible substance, in accordance with an embodiment of the present invention; and

FIG. 5 illustrates a sectioned side view of an alternative bottle accessory device wherein the alternative device is placed on a long neck bottle and the device has a removable top.

### DESCRIPTION

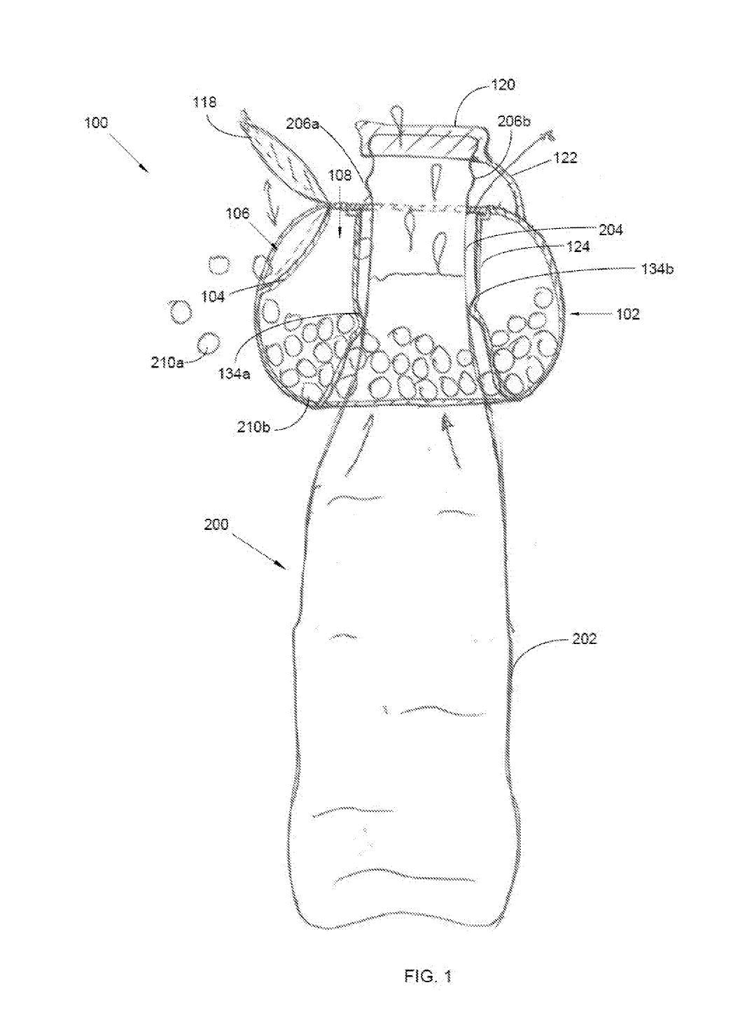

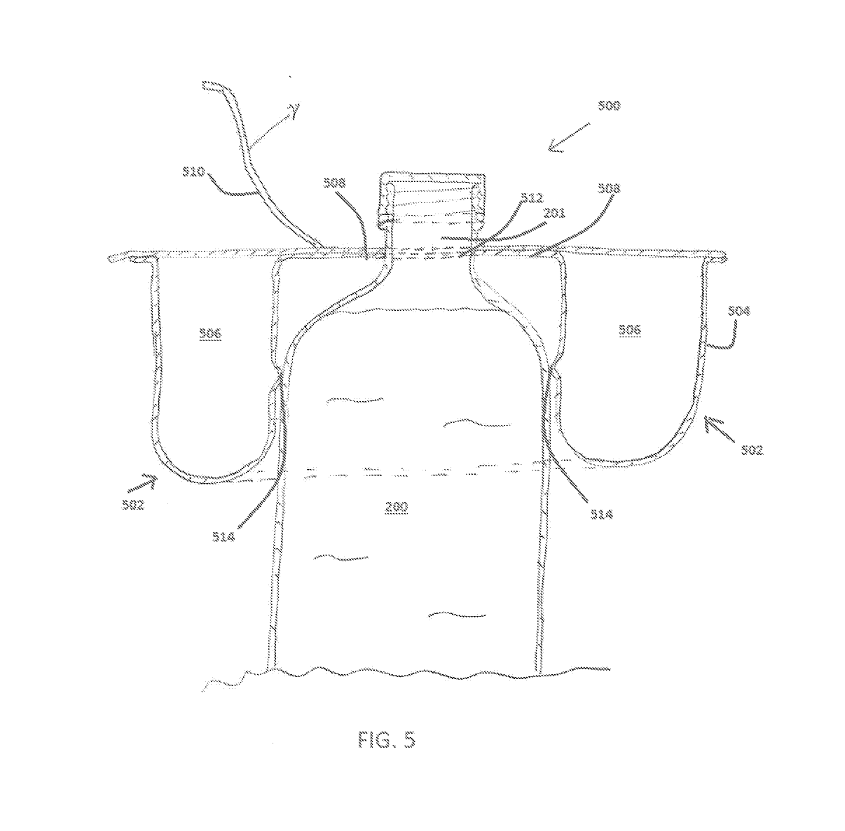

The present invention, referenced in FIGS. 1-5, is directed to a bottle accessory device 100 and method 300 for attaching to a bottle and dispensing edible substances. The bottle accessory device 100, hereafter “device 100” is configured to simultaneously store and dispense an edible substance 210a, 210b, while being detachably joined with a bottle 200 containing a liquid. In some embodiments, the device 100 may have a generally annular, cavernous configuration that forms a snug encirclement with a neck portion 204 of the bottle 200 while storing and dispensing the edible substance 210a, 210b.

The bottle 200, which the device 100 is operable with, may include a glass or plastic bottle known in the art for containing an edible liquid substance. The bottle 200 generally has a wide body portion 202 that contains the liquid, and a narrow neck portion 204 having at least one flange 206a, 206b and terminating at a bottle opening 208 sized to dispense the liquid from the body portion 202. Those skilled in the art will recognize that the flange 206a, 206b may extend generally perpendicular from the neck portion 204. The device 100 engages the flange 206a, 206b to form a secure attachment with the neck portion 204 of the bottle 200.

In one embodiment, the device 100 utilizes a unique resilient gasket 124 to snugly encircle the neck portion 204 of the bottle 200. A plurality of resilient protruding members 134a, 134b extend from the resilient gasket 124 to engage the at least one flange 206a, 206b of the neck portion 204, and thereby form a secure attachment with the neck portion 204. This secure, yet detachable arrangement between the device 100 and the bottle 200 enables one-handed, simultaneous consumption of the liquid from the bottle 200 and the edible substance 210a, 210b contained in the device 100.

In this manner, a user may consume the liquid in the bottle 200 and the edible substance 210a, 210b in the bottle 200 accessory device 100 while performing functions, such as walking, exercising, driving, and talking on the phone. Those skilled in the art will recognize that most food and liquid containment devices for carrying drinks and snack foods are bulky and difficult to hold. Users are prone to tipping their drinks and require safeguards to keep liquids and snacks from spilling out on to adjacent surfaces. Further, most containment devices of this nature are not designed to contain healthy, nutritious edible substances in the form of both a liquid and a solid.

As referenced in FIG. 1, the device 100 comprises a generally annular body 102 defined by a continuous sidewall 104 and a cavity 108. The continuous sidewall 104 is generally smooth and forms a continuous circle. A sidewall opening 106 forms in the sidewall 104 to enable access to an edible substance 210a, 210b stored in the cavity 108. The annular body 102 is flexible, so as to enable depressing to force edible substance 210a, 210b from the cavity. The annular body 102 may be fabricated from a plastic, such as polyurethane, silicone, or other flexible material. The annular body 102 may also fabricated from an anti-bacterial material, or stainless steel.

The cavity 108 that forms in the annular body 102 is continuous and configured to contain an edible substance 210a, 210b. The edible substance 210a, 210b contained in the cavity 108 may include, without limitation, raisins, nuts, seeds, granola mix, fruit, vegetables, candy, pills, tablets, a health shake, a fruit juice, yogurt, milk, medicine, and mineral water. In one operational embodiment, depressing along the length of the annular body 102 forces air and the edible substance 210a, 210b out through the sidewall opening 106.

The annular body 102 is further defined by an inner perimeter 112 and an outer perimeter 110. The perimeters form the extreme boundaries for the annular body 102. The annular body 102 is further defined by a body hole 114 having a first diameter 116. The first diameter 116 is generally larger than the diameter of the neck portion 204 of the bottle 200, so as to enable full encirclement of the neck portion 204 of the bottle 200.

In some embodiments, a gate 118 enables access to the cavity 108 of the annular body 102. The gate 118 may hingedly move between an open position and a closed positon over the sidewall opening 106. However, in some embodiments, the gate 118 may slide between the open and closed positions. When in the open position, the sidewall opening 106 in the continuous sidewall 104 enables the edible substance 210a, 210b to be filled or dispensed from the cavity 108 of the annular body 102. FIG. 1 illustrates the gate 118 hingedly moved to the open position. The gate 118 can be manipulated with one hand.

In other embodiments, a cap 120 extends from the outer perimeter 110 of the annular body 102. The cap 120 is sized and dimensioned to substantially match the length and width of the bottle opening 208. The cap 120 may form a friction fit relationship with the bottle opening 208, so as top seal closed the bottle opening 208. A flexible rod 122 may connect the cap 120 to the outer perimeter 110 of the annular body 102. In this manner, the cap 120 remains attached, but moves freely relative to the annular body 102 to cover and uncover the bottle opening 208.

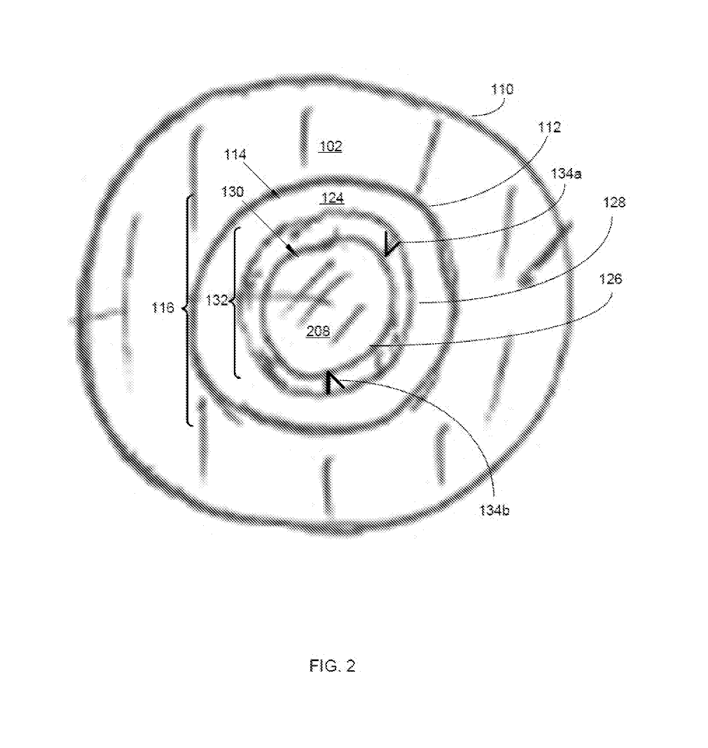

Looking down from the top view shown in FIG. 2, the device 100 further comprises a generally resilient gasket 124 that affixes inside the annular body 102 and engages the neck portion 204 of the bottle 200. The resilient gasket 124 is defined by an inner edge 126, an outer edge 128, and a gasket hole 130. The resilient gasket 124 is disposed generally coplanar to the annular body 102. In this manner, the outer edge 128 of the resilient gasket 124 fixedly fits inside the inner perimeter 112 of the annular body 102. The resilient gasket 124 may include a rubber or flexible polymer seal such as a gasket, O-ring, and flap.

The gasket hole 130 is also defined by a second diameter 132 that extends across the gasket hole 130. The second diameter 132 is generally smaller than the first diameter 116 of the body hole 114 of the annular body 102. The second diameter 132 substantially matches the diameter of the neck portion 204 of the bottle 200, so as to form a snug relationship therebetween. In one embodiment, the second diameter 132 of the gasket hole 130 is about 0.400 to 0.500 millimeters.

In some embodiments, a plurality of resilient protruding members 134a, 134b extend from the inner edge 126 of the resilient gasket 124, and partially across the gasket hole 130. The resilient protruding members 134a, 134b are disposed generally perpendicular to the resilient gasket 124. The resilient protruding members 134a, 134b are oriented in the same direction.

In some embodiments, the resilient protruding members 134a, 134b bend when engaging the at least one flange 206a, 206b of the neck portion 204 of the bottle 200. In this manner, the resilient protruding members 134a, 134b are configured to facilitate motion of the device 100 in a first direction, and restrict motion of the device 100 in a second direction.

For example, the resilient protruding members 134a, 134b restrict movement of the device 100 away from a body portion 202 of the bottle 200, such as when removing the device 10 from the bottle 200. Conversely, the resilient protruding members 134a, 134b are configured to facilitate movement of the device 100 towards the body portion 202 of the bottle 200, such as when affixing the device 100 to the neck portion 204 of the bottle 200.

This results in the bottle 200 accessory device 100 being easy fitting onto the neck portion 204 of the bottle 200, but difficult to remove from neck portion 204 of the bottle 200. Further, the bottle 200 accessory device 100 does not substantially move when affixed to the neck portion 204 of the bottle 200. In this manner, the liquid in the bottle 200 may be consumed without having to remove the device 100.

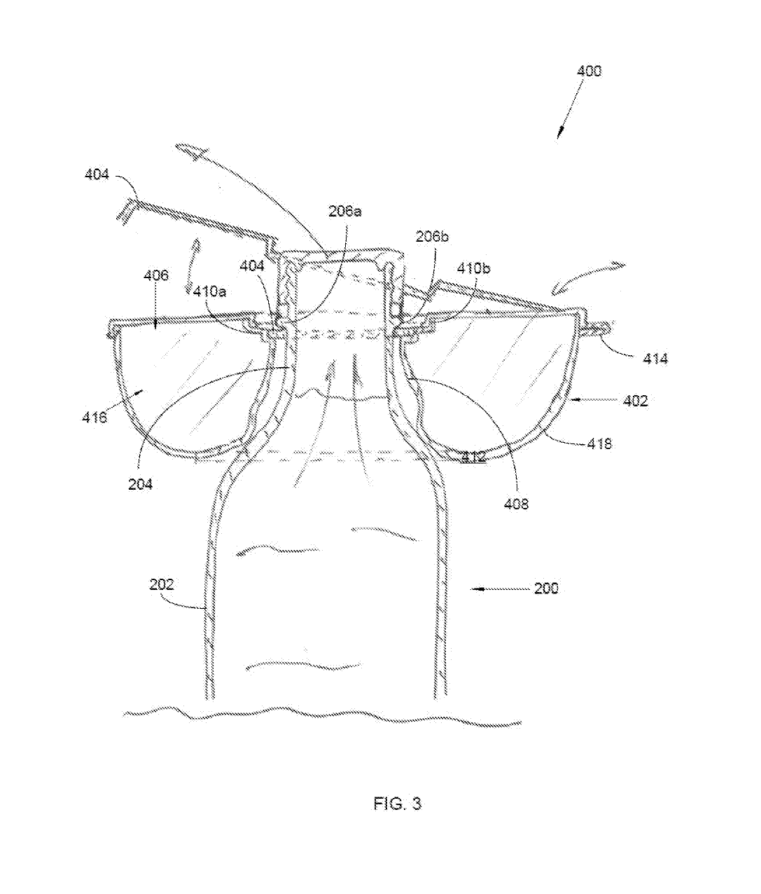

In one alternative embodiment illustrated in FIG. 3, an alternative form of a bottle accessory device 400 has a clam shell configuration in which an annular body 402 is bifurcated into an open faced bottom section 418 and a hinged lid 404. The hinged lid 404 connects to a sidewall 412 of the annular body 402 at a hinge mechanism 414. The hinged lid 404 is configured to hingedly move between an open position and a closed position across an opening 406 in the annular body 402. Similar to the prior embodiment of the device 100, a cavity 416 contains the edible substance, and access thereto is regulated by the hinged lid 404.

Thus, the hinged lid 404 extends the entire length of the sidewall 412 of the annular body 402. In essence, the hinged lid 404 replaces the gate 118 that covers the sidewall opening 106 in the prior embodiment of the device 100. Similar to the aforementioned embodiment, a resilient gasket 408 comprises a plurality of resilient protruding members 410a, 410b that engage at least one flange 206a, 206b in the neck portion 204 of the bottle 200.

In another alternative embodiment of device 100, at least one barrier is disposed transversely to the sidewall inside the cavity of the annular body. The at least one barrier segregates the different edible substances from each other. The barrier may segregate solid from liquid edible substances; and further, may segregate multiple solids from each other, and multiple liquids from each other. Each barrier forms a plurality of compartments for this purpose.

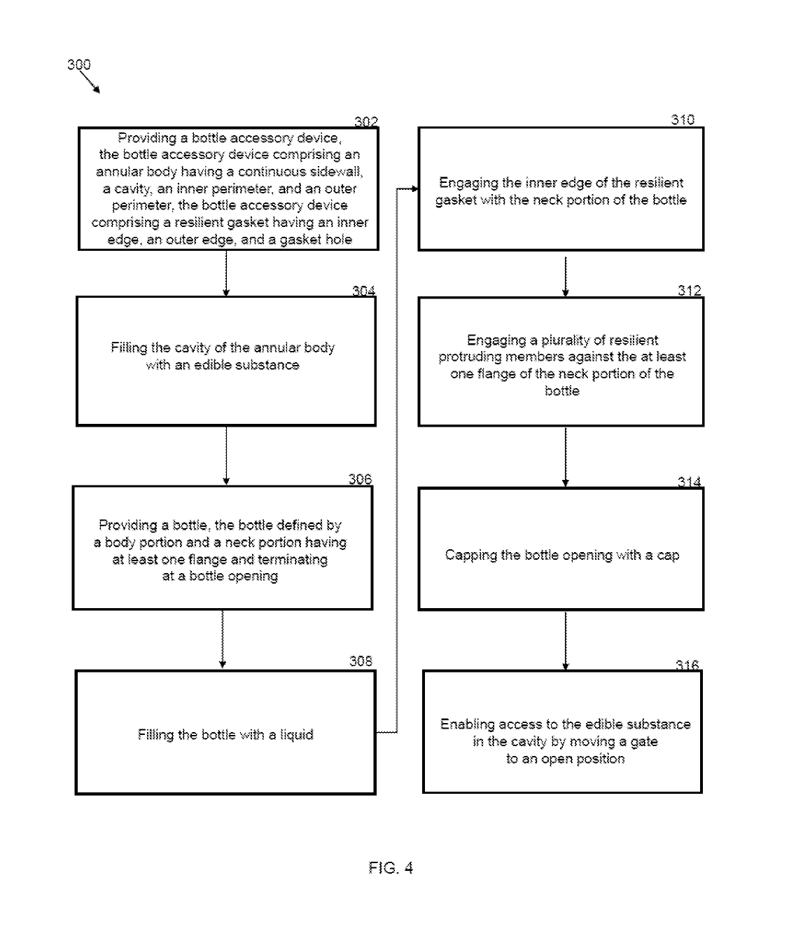

FIG. 4 references a flowchart diagram of a method 300 for attaching to a bottle and dispensing an edible substance. The method 300 may include an initial Step 302 of providing a bottle accessory device 100, the bottle accessory device 100 comprising an annular body defined by a continuous sidewall, a cavity, an inner perimeter, and an outer perimeter, the bottle accessory device further comprising a resilient gasket defined by an inner edge, an outer edge, and a gasket hole.

The method 300 may further comprise a Step 304 of filling the cavity of the annular body with an edible substance. The edible substance may include a solid, semi-solid, or liquid food.

A Step 306 includes providing a bottle 200, the bottle defined by a body portion and a neck portion having at least one flange and terminating at a bottle opening. The bottle 200, which the device 100 is operable with, may include a glass or plastic bottle known in the art for containing an edible liquid substance. The bottle 200 generally has a wide body portion 202 that contains the liquid, and a narrow neck portion 204 having at least one flange 206a, 206b and terminating at a bottle opening 208 sized to dispense the liquid from the body portion 202.

In some embodiments, a Step 308 comprises filling the bottle with a liquid. The liquid may include an edible liquid substance, including soda, milk, mineral water, and juice.

A Step 310 includes engaging the inner edge of the resilient gasket with the neck portion of the bottle. In some embodiments, a plurality of resilient protruding members 134a, 134b extend from the inner edge 126 of the resilient gasket 124, and partially across the gasket hole 130. The resilient protruding members 134a, 134b are disposed generally perpendicular to the resilient gasket 124. The resilient protruding members 134a, 134b are oriented in the same direction.

In some embodiments, a Step 312 may include engaging a plurality of resilient protruding members against the at least one flange of the neck portion of the bottle. In some embodiments, the resilient protruding members 134a, 134b bend when engaging the at least one flange 206a, 206b of the neck portion 204 of the bottle 200. In this manner, the resilient protruding members 134a, 134b are configured to facilitate motion of the device 100 in a first direction, and restrict motion of the device 100 in a second direction.

A Step 314 comprises capping the bottle opening with a cap 120. The cap 120 extends from the outer perimeter 110 of the annular body 102. The cap 120 is sized and dimensioned to substantially match the length and width of the bottle opening 208. The cap 120 may form a friction fit relationship with the bottle opening 208, so as top seal closed the bottle opening 208.

A final Step 316 includes enabling access to the edible substance in the cavity by moving a gate 118 to an open position. In some embodiments, a gate 118 enables access to the cavity 108 of the annular body 102. The gate 118 may hingedly move between an open position and a closed positon over the sidewall opening 106.

In an alternative embodiment of the present device 500, the device 500 comprises of an annular body 502 defined by a continuous side wall 504 and a cavity 506. The annular body defines a top side 508 that is covered by a removable top 510 that covers the cavity 506. The top side of the body defines a central opening 512 that is made to fit over a spout 201 of a bottle 200. The annular body defines a protruding ring 514 that protrudes from the annular body 502 toward the bottle 200 that device 500 is placed on.

While the inventor's above description contains many specificities, these should not be construed as limitations on the scope, but rather as an exemplification of several preferred embodiments thereof. Many other variations are possible. For example, the cavity 108 may include at least one barrier that forms compartments in the annular body 102, with each compartment containing a different edible substance 210a, 210b. Accordingly, the scope should be determined not by the embodiments illustrated, but by the appended claims and their legal equivalents.

What is claimed is:

1. A bottle accessory device, the device comprising:
a annular body defined by a cavity and a continuous sidewall having a sidewall opening, the annular body further defined by an inner perimeter and an outer perimeter, the annular body further defined by a body hole having a first diameter;
a gate configured to enable access to the cavity of the annular body, the gate configured to at least partially extend across the sidewall opening;
a cap configured to extend from the outer perimeter of the annular body, the cap further configured to move freely relative to the annular body;
a resilient gasket defined by an inner edge, an outer edge, and a gasket hole, the resilient gasket disposed generally coplanar to the annular body, the outer edge of the resilient gasket configured to join with the inner perimeter of the annular body, the gasket hole having a second diameter configured to be smaller than the first diameter of the body hole; and
a plurality of resilient protruding members configured to extend from the inner edge of the resilient gasket, the plurality of resilient protruding members disposed perpendicular to the resilient gasket, the plurality of resilient protruding members configured to orient inward from the annular body, whereby the plurality of resilient protruding members are configured to facilitate motion of the device in a first direction, and restrict motion of the device in a second direction.

2. The device of claim 1, wherein the annular body is fabricated from plastic.

3. The device of claim 1, wherein the continuous sidewall of the annular body is smooth.

4. The device of claim 1, wherein the outer edge of the resilient gasket is configured to fixedly attach to the inner perimeter of the annular body.

5. The device of claim 1, wherein the gate is configured to hingedly move between an open position and a closed position over the sidewall opening.

6. The device of claim 1, wherein the hinged cap comprises a flexible rod configured to extend between the outer perimeter of the annular body and the hinged cap.

7. The device of claim 1, wherein the second diameter of the gasket hole is generally between 0.400 and 0.500 millimeters.

8. The device of claim 1, wherein the gasket hole is configured to enable engagement with a neck portion of a bottle.

9. The device of claim 8, wherein the bottle is configured to contain a liquid.

10. The device of claim 9, wherein the bottle is defined by a body portion and a neck portion having at least one flange and terminating at a bottle opening.

11. The device of claim 10, wherein the plurality of resilient protruding members are configured to engage at least one flange of the neck portion of the bottle.

12. The device of claim 11, wherein the plurality of resilient protruding members are configured to restrict movement of the device away from a body portion of the bottle.

13. The device of claim 12, wherein the plurality of resilient protruding members are configured to facilitate movement of the device towards the body portion of the bottle.

14. The device of claim 13, wherein the plurality of resilient protruding members are configured to bend when engaging the at least one flange of the neck portion of the bottle.

15. The device of claim 1, wherein the cavity is configured to enable containment of an edible sub stance.

16. The device of claim 15, wherein the edible substance includes at least one member selected from the group consisting of: raisins, nuts, seeds, granola mix, fruit, vegetables, candy, pills, tablets, a health shake, a fruit juice, yogurt, milk, medicine, and mineral water.

17. A bottle accessory device, the device comprising:
a annular body defined by a clam shell configuration, the annular body being bifurcated into an open faced bottom section and a hinged lid, the hinged lid configured to hingedly move between an open positon and a closed positon across the open faced bottom section, the annular body further defined by a sidewall and a cavity, the annular body further defined by an inner perimeter and an outer perimeter, the annular body further defined by a body hole having a first diameter, the annular body having a clam shell configuration that hingedly moves between an open position and a closed position;
a resilient gasket defined by an inner edge, an outer edge, and a gasket hole, the resilient gasket disposed generally coplanar to the annular body, the outer edge of the resilient gasket configured to join with the inner perimeter of the annular body, the gasket hole having a second diameter configured to be smaller than the first diameter of the body hole; and
a plurality of resilient protruding members configured to extend from the inner edge of the resilient gasket, the plurality of resilient protruding member disposed generally perpendicular to the resilient gasket, whereby the plurality of resilient protruding members are configured to facilitate motion of the device in a first direction, and restrict motion of the device in a second direction.

18. The device of claim 17, wherein the outer edge of the resilient gasket is configured to fixedly attach to the inner perimeter of the annular body.

19. The system of claim 17, wherein the gasket hole is configured to enable engagement with a neck portion of a bottle.

20. A bottle accessory device, the device comprising:
an annular body that is defined by a continuous side wall and a cavity, the annular body defines a top side, the top side of body defines a central opening that is made to fit over a spout of a bottle, and a protruding ring that protrudes from the annular body toward the bottle 200 that device is placed on; and
a removable top that is attached to the top side of the annular body and that covers the cavity.
